(19) United States
(12) Patent Application Publication
(10) Pub. No.: US 2006/0187010 A1
(43) Pub. Date: Aug. 24, 2006

(54) Vehicle motion warning device

(76) Inventor: Herbert Berman, East Falmouth, MA (US)

Correspondence Address: Gordon & Jacobson, P.C., Suite 407, 60 Long Ridge Road, Stamford, CT, 06902, US

(21) Appl. No.: 11/061,808

(22) Filed: Feb. 18, 2005

(51) Int. Cl. B60Q 1/00; G01S 13/00; B60T 7/16; G08G 1/14

(52) U.S. Cl. 340/435; 340/932.2; 342/54; 342/70; 180/169

(57) ABSTRACT

A device is disclosed which is adapted to be mounted on a vehicle to generate a warning pattern on the pavement near the vehicle. An intense, narrow light beam from a laser is directed downward from the device to generate a distinctly visible illuminated warning pattern on the pavement to warn of, for example, the backing-up of the vehicle or, when the vehicle is moving forward, to provide an indication of a safe clearance distance for a following vehicle. Also disclosed is such a device for providing a warning pattern in front of or beside the vehicle.

### FIELD OF THE INVENTION

The invention relates generally to devices for warning of the motion of a vehicle and more specifically to a device which uses an intense, narrow light beam directed to the driving surface for providing an illuminated warning pattern on that surface.

### BACKGROUND OF THE INVENTION

Motor vehicles, such as trucks and automobiles, which are proceeding in a reverse direction mode present a danger to other vehicles and to pedestrians situated behind them or otherwise so located or proceeding as to result in a possible collision. For this reason there are presently in use numerous warning devices for alerting others to the motion of the vehicle.

One such warning device is an intermittent sound generator (“beeper”) on the vehicle which is automatically activated when the vehicle is in the reverse mode to warn those in the vicinity of its reverse mode condition. A drawback of this device is that it may not be sensed by those with hearing disabilities. It also leaves it difficult to identify the precise location of the vehicle when it is located in a large group of other vehicles, such as may be the case for an automobile in a parking lot.

Another such warning device is an illuminating light at the rear of the vehicle (“back-up light”) which is automatically activated whenever the vehicle is in the reverse mode and acts to both illuminate the reverse path of the vehicle and to warn those who see it of the vehicle's reverse mode condition. A drawback of this device is that it is not always visible to those in danger. For example, a smaller automobile parked immediately adjacent a larger vehicle may have its back-up lights blocked by that larger vehicle from the view of someone approaching the rear orthogonally from that side, such as in the course of proceeding along the aisle of a parking lot. Even a flashing light on the roof of a vehicle can be obstructed by a taller, adjacent vehicle or other obstruction from the view of an approaching vehicle or pedestrian. Although the back-up light illuminates objects behind the vehicle and may thereby provide some warning in that regard, under some conditions there are no nearby objects to be illuminated. The surface behind the vehicle may also not reflect enough light, especially in wet conditions, to provide sufficient warning of the presence of the vehicle. Moreover, even when some illumination of and reflection from nearby objects is detected, such as from other vehicles behind the vehicle or from the pavement surface behind that vehicle, this reflection may be so diffuse that the location of the vehicle from which the light emanates is not clear.

There is a need for a warning device for a vehicle in or about to be in motion which not only warns of the vehicle's condition, but also provides to someone in its vicinity a clear indication of where the vehicle is and to where it is proceeding.

### SUMMARY OF THE INVENTION

In accordance with the novel combination of the present invention a warning device comprising a light source is adapted to be mounted on a vehicle and to project at least one narrow beam of intense light on the driving surface near the vehicle, whereby a distinctly visible warning pattern is generated on the driving surface near the vehicle to warn of the presence and location of the vehicle.

### BRIEF DESCRIPTION OF THE DRAWINGS

FIG. 1 is a schematic sketch plan view of a group of automobiles in a parking lot, with one of the vehicles being provided with a device in accordance with one embodiment of the invention.

FIG. 2 is a schematic sketch side view of the one vehicle of FIG. 1.

### DETAILED DESCRIPTION

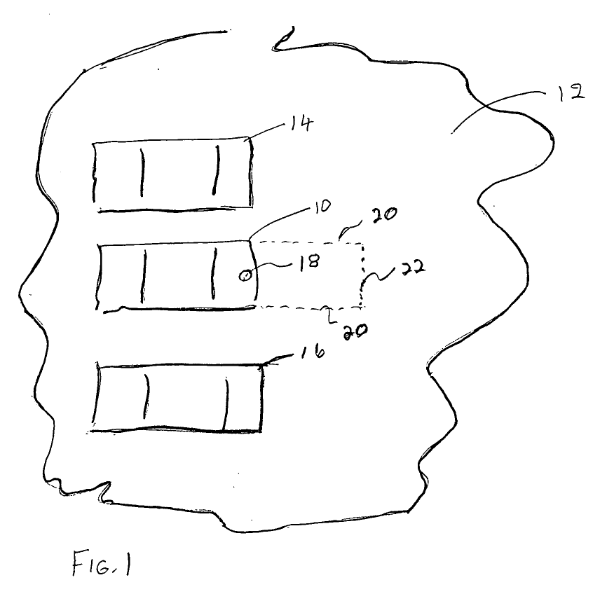

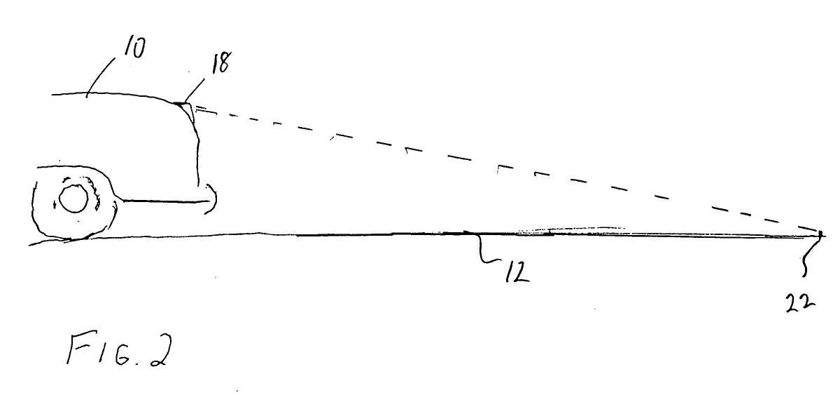

In accordance with one embodiment of the invention, shown in FIGS. 1 and 2 of the drawings, a first automobile 10 is parked in a parking lot having a pavement driving surface 12. The first automobile 10 is parked between an immediately adjacent second automobile 14 on one side and an immediately adjacent third automobile 14 on the other side. The first automobile 10 is provided with a warning device 18 which projects a narrow beam of intense light onto the pavement 12 behind the first vehicle 10 to generate on the pavement 12 two distinctly visible warning lines 20 parallel to the sides of the vehicle 10. Warning lines 20 are preferably separated from each other by and therefore indicate the actual width of the vehicle 10. The device 18 also generates on the pavement 12 a third, warning line 22 orthogonal to the width warning lines 20. The third warning line 22 is preferably spaced from the rear of the vehicle 10 a distance equal to the length of the vehicle 10. Together, the “width” warning lines 20 and the “length” warning line 22 form a highly visible rectangular frame on the pavement behind the vehicle 10 indicating the size and location of the vehicle 10. The frame can be readily seen from a distance by an automobile operator or pedestrian approaching the rear of the vehicle 10 from the side, such as along a parking lot corridor, and thus provides a warning that the vehicle is about to back out of its parking place into the corridor.

The light beam source of the warning device 18 can be a laser having a maximum output intensity of 5 milliwatts or lower, which is low enough to need no special government agency approvals on the basis of health concerns. The intensity of an ordinary ruby laser of 630-680 nanometer wavelength in a laser pointer or laser level of the type presently marketed to the general public is sufficient to provide a highly visible distinct illuminated pattern on the pavement behind the vehicle. Moreover, since the beam is directed in the downward direction, the likelihood of having even a child or pet look directly into the light source is minimal. In order to reduce this likelihood to the lowest feasible level, the device 18 can be mounted as low as feasible on the vehicle 10.

The precise means for obtaining the warning pattern illumination is not important to the inventive concept. Means for accomplishing this are well known in the art. For example, it is known to use beam splitters to generate more than one beam from a single laser source. Likewise, it is known to use a slit to generate a line beam from a spot beam. A laser beam can also be deflected by a steered mirror to generate a selected desired pattern. The mirror may be steered by orthogonal deflection electromagnets driven by signals from a general purpose computer coupled to an electronic driving circuit. Alternatively, the laser itself can be similarly steered. The selected pattern may be more than the frame formed by the width warning lines 20 and the length warning line 22 of the above-described embodiment. With a steering mechanism for the beam, any desired pattern, such as even a verbal warning can be written on the pavement. Examples of warnings are “STOP”, “BACKING”, “CAR”, and “CAUTION”. Moreover, the light beam may be intermittent to draw attention. Also, multiple laser devices can be used, such as a separate device mounted at each side of the vehicle for respectively generating each of the side warning lines 20 and a third one at a location between them for generating the length warning line 22.

While for the vehicle 10 of the above-described embodiment a laser generates the beam of the warning device 18, a suitable beam for generating the warning marking could also be some other light source, such as an incandescent, vapor, or even light emitting diode light, provided it is appropriately focused to a beam sufficiently narrow and intense to be capable of generating well-defined bright warning lines or dots clearly visible on the driving surface. By “narrow” is meant having a width such that a distinctly visible line or dot may be generated on the pavement. This is to be distinguished from the type of broad illumination of the pavement provided by headlamps or back-up lights which have relatively large and diffuse beams that illuminate a large pavement surface with no distinct pattern. The color of the light may be selected as desired, depending upon the colors available from the type of light source used and the type of warning given.

Any desired number of devices in accordance with the invention may be provided on a vehicle to provide any or all of the functions of: providing a warning pattern in the rear for the reverse mode or for a safe clearance in the forward mode (as described hereinafter); providing a warning pattern in front of the vehicle for instances when it leaves a parking place in the forward mode; providing a warning pattern beside the vehicle for warning of various conditions. For example, a device generating a line projected in front of the vehicle on the passenger side indicating the location of the outside sidewall of the front tire there may be useful as a guide to the vehicle operator to prevent damaging contact of the tire sidewall with a curbing when parking the vehicle.

The devices in accordance with the invention may be mounted on the vehicle in any location suitable for the function to be served. For example, separate devices for side warning lines may be mounted as a component of the tail lights or backup light assemblies on each side. A device mounted centrally on the rear may generate a length warning line. However, this line could also be generated by the side warning line generating devices if they are provided with suitable optics for that purpose.

Any or all the warning devices mounted on a vehicle may be activated automatically by other equipment on the vehicle or manually by the provision of appropriate switching circuitry known in the automotive electronics art.

Although the warning device of the present invention is particularly useful for warning of the reverse movement of a vehicle, it can be used for various other puposes. For example, it can be used when moving forward to mark on the pavement behind the vehicle a clearance line indicating a safe clearance distance for a following, second vehicle. The device may be coupled to the speed sensor of the vehicle through a computer to automatically select the appropriate location of the clearance line for a given speed, such as approximately one automobile length for each 10 miles per hour speed. A distance detecting device, such as an ultrasound ranging device, could be added to sound an alarm or write a warning on the pavement behind the vehicle if the following vehicle is too close. The device could also be adapted to write messages on the pavement behind or beside the vehicle to be read by the following vehicle. For example, it could be used to write “CAUTION”or “STOP” beside or behind a school bus discharging or about to halt to discharge passengers.

If it is thought important to prevent a beam or beams of the warning device from impinging directly on the eye of a child or perhaps directly behind the vehicle, there can be provided a motion detector which shuts off the warning device. Motion detectors suitable for this purpose are well known in the art and are relatively inexpensive. Even with the warning pattern generating device switched off, a person directly behind the vehicle would in any case be in a position to see the backup light normally provided at the rear of the vehicle.

1. A device adapted to be mounted on a vehicle and capable of warning of the motion of the vehicle on a driving surface, the device comprising:
a light source adapted to project a narrow beam of intense light onto the driving surface near the vehicle to generate a distinctly visible warning pattern on the driving surface near the vehicle to warn of the presence and location of the vehicle.

2. The device according to claim 1 wherein the light source is a laser and the beam is coherent light with a width of less than one centimeter where it impinges on the driving surface.

3. The device according to claim 2 comprising means for steering the beam to scan a pattern on the driving surface.

4. The device according to claim 1 wherein the pattern has outside dimensions indicating the width dimensions of the vehicle.

5. The device according to claim 4 wherein the pattern has a width approximately that of the vehicle and a length approximately that of the vehicle.

6. The device according to claim 5 wherein the pattern includes a verbal warning.

7. The device according to claim 1 wherein the beam is made intermittent to draw attention.

8. The device according to claim 1 wherein the beam is projected from the rear of the vehicle.

9. The device according to claim 8 wherein the beam is projected to an area on the driving surface behind the vehicle approximately the same area as the area on the driving surface occupied by the vehicle itself.

10. The device according to claim 8 wherein the beam projects side indicator lines on the driving surface indicating the width of the vehicle.

11. The device according to claim 9 wherein the lines a parallel to each other.

12. The device according to claim 11 wherein the beam additionally projects a line generally orthogonal to the side indicator lines and spaced from the end of the vehicle approximately the length of the vehicle.

13. The device according to claim 8 wherein the beam projects a clearance mark on the driving surface to the rear of the vehicle to indicate to following traffic a distance from the vehicle which is considered safe traffic clearance at the speed the vehicle is moving forward.

14. The device according to claim 13 including means for adjusting the following traffic clearance to be appropriate to the speed.

15. The device according to claim 14, wherein the adjustment is automatically made by a computer in response to information from a means for sensing the speed of the vehicle.

16. The device according to claim 1, wherein the beam projects from the side of the vehicle to display a warning on the driving surface beside the vehicle.

17. The device according to claim 16 wherein the vehicle is a school bus and the warning is adapted to be seen by a driver of following traffic.

18. The device according to claim 17 wherein the warning is for the following traffic to stop.
